(19) United States
(12) Patent Application Publication
(10) Pub. No.: US 2015/0178895 A1
(43) Pub. Date: Jun. 25, 2015

(54) IMAGE PROCESSING DEVICE AND IMAGE PROCESSING METHOD

(71) Applicant: PANASONIC INTELLECTUAL PROPERTY MANAGEMENT CO., LTD., Osaka (JP)

(72) Inventors: Yoshiaki OWAKI, Osaka (JP); Natsuki SAITO, Osaka (JP)

(21) Appl. No.: 14/639,105

(22) Filed: Mar. 4, 2015

Related U.S. Application Data
(63) Continuation of application No. PCT/JP2012/008390, filed on Dec. 27, 2012.

(51) Int. Cl. G06T 3/40; G06K 9/46; G06T 5/00

(52) U.S. Cl. CPC G06T 3/4092; G06T 5/003; G06K 9/4604; G06T 2200/16; G06T 2207/10016; G06T 2207/20182

(57) ABSTRACT

An image processing device includes: a character region detecting unit which detects a character region including a character from an input image; a feature amount detecting unit which detects a feature amount indicating a level of deformation of an image in the character region detected by the character region detecting unit; a correction gain calculating unit which calculates a correction gain based on the feature amount detected by the feature amount detecting unit; and a correcting unit which corrects the input image by performing image processing on the image in the character region such that the image processing has an effect which decreases with a decrease in the correction gain calculated by the correction gain calculating unit.

### CROSS REFERENCE TO RELATED APPLICATION

This is a continuation application of PCT Patent Application No. PCT/JP2012/008390 filed on Dec. 27, 2012, designating the United States of America. The entire disclosure of the above-identified application, including the specification, drawings and claims is incorporated herein by reference in its entirety.

### FIELD

The present disclosure relates to image processing devices and image processing methods.

### BACKGROUND

Patent Literature (PTL) 1 (Japanese Unexamined Patent Application Publication No. 2008-113124) discloses an image processing device which detects pixels having brightness differences as a character region and increases smoothing effects in the character region. The image processing device detects the character region with a simple character detection.

### SUMMARY

The present disclosure provides an image processing device which increases sharpness of one or more characters in an image.

An image processing device according to the present disclosure includes: a character region detecting unit which detects a character region including a character from an input image; a feature amount detecting unit which detects a feature amount indicating a level of deformation of an image in the character region detected by the character region detecting unit; a correction gain calculating unit which calculates a correction gain based on the feature amount detected by the feature amount detecting unit; and a correcting unit which corrects the input image by performing image processing on the image in the character region, the image processing having an effect which decreases with a decrease in the correction gain calculated by the correction gain calculating unit.

### BRIEF DESCRIPTION OF DRAWINGS

These and other objects, advantages and features of the invention will become apparent from the following description thereof taken in conjunction with the accompanying drawings that illustrate a specific and non-limiting embodiment of the present invention.

FIG. 1 is a functional block diagram of an image processing device according to Embodiment 1.

FIG. 2 is a detailed functional block diagram of a character region detecting unit according to Embodiment 1.

FIG. 3 illustrates processing performed by the character region detecting unit according to Embodiment 1.

FIG. 4A illustrates a method of counting pixels used by a character level determining unit according to Embodiment 1.

FIG. 4B illustrates an example of character block values according to Embodiment 1.

FIG. 5 illustrates a method of calculating a character probability performed by a character determining unit according to Embodiment 1.

FIG. 6 is a detailed functional block diagram of a character size detecting unit according to Embodiment 1.

FIG. 7 illustrates a method of calculating a character size performed by the character size determining unit according to Embodiment 1.

FIG. 8 is a detailed functional block diagram of a brightness change count calculating unit according to Embodiment 1.

FIG. 9 is a detailed functional block diagram of a horizontal change calculating unit according to Embodiment 1.

FIG. 10 is a detailed functional block diagram of a vertical change calculating unit according to Embodiment 1.

FIG. 11 is a detailed functional block diagram of a correction gain calculating unit according to Embodiment 1.

FIG. 12 illustrates processing for calculating a correction gain performed by the correction gain calculating unit according to Embodiment 1.

FIG. 13 is a detailed functional block diagram of a correcting unit according to Embodiment 1.

FIG. 14 is a detailed functional block diagram of a smoothing unit according to Embodiment 1.

FIG. 15 is a detailed functional block diagram of a sharpening unit according to Embodiment 1.

FIG. 16 illustrates unsharp masking performed by the sharpening unit according to Embodiment 1.

FIG. 17 is a flowchart of processing performed by the image processing device according to Embodiment 1.

FIG. 18A is a functional block diagram of an image processing device according to Embodiment 2.

FIG. 18B is a functional block diagram of an image processing device according to Variation of Embodiment 2.

FIG. 19 illustrates an example of an external view of the image processing device according to each embodiment.

### DESCRIPTION OF EMBODIMENTS

Hereinafter, non-limiting embodiments will be described in detail with reference to the accompanying drawings. Unnecessarily detailed description may be omitted. For example, detailed descriptions of well-known matters or descriptions previously set forth with respect to structural elements that are substantially the same may be omitted. This is to avoid unnecessary redundancy in the descriptions below and to facilitate understanding by those skilled in the art.

It should be noted that the inventors provide the accompanying drawings and the description below for a thorough understanding of the present disclosure by those skilled in the art, and the accompanying drawings and the descriptions are not intended to be limiting the subject matter recited in the claims appended hereto.

First, problems to be solved by the present disclosure will be described.

In general, the resolution of content on a standard definition (SD) television, a digital versatile disc (DVD), or the internet is 360 p (the number of pixels in the longitudinal direction is 360) or 480 p approximately. When such content (low-resolution content) is to be displayed on a higher-resolution display panel, higher-resolution content is generated by performing enlarging processing on the low-resolution content to increase the resolution of the content. In low-resolution content including one or more characters added by image processing or the like, the enlarging processing may, for example, cause the characters to be blurry. Another example is that the enlarging processing may enlarge coding distortion present between a character and a neighboring image or enlarge character shape deformation. This causes the coding distortion or the character shape deformation to be more noticeable than the pre-enlargement state. In particular, the latter phenomenon is likely to occur in low-resolution or low bit-rate content, and in a region of the content where lines of characters are concentrated. In other words, the enlarging processing may cause the images of the characters to be deformed. A viewer of content finds such characters including the image deformation illegible.

PTL 1 discloses an image processing device which detects pixels having brightness differences as a character region and increases smoothing effects in the character region. The image processing device detects the character region with a simple character detection. Unfortunately, image processing performed on the detected character region is inappropriate, which leaves the above problems unsolved.

The present disclosure provides an image processing device which increases sharpness of one or more characters in an image.

An image processing device according to the present disclosure includes: a character region detecting unit which detects a character region including a character from an input image; a feature amount detecting unit which detects a feature amount indicating a level of deformation of an image in the character region detected by the character region detecting unit; a correction gain calculating unit which calculates a correction gain based on the feature amount detected by the feature amount detecting unit; and a correcting unit which corrects the input image by performing image processing on the image in the character region, the image processing having an effect which decreases with a decrease in the correction gain calculated by the correction gain calculating unit.

With this, the image processing device performs image processing on the character region in an input image to increase sharpness according to the feature amount (image processing which has an effect according to the feature amount). The feature amount indicates the level of deformation of an image in the character region caused by the enlarging processing performed on the input image. Hence, the image processing device corrects the image deformation appropriately by performing image processing based on the feature amount. Accordingly, the image processing device increases sharpness of the characters in an image.

Moreover, it may be that the feature amount detecting unit includes a character size detecting unit which detects a character size as the feature amount, the character size being a size of the character in the character region, and the correction gain calculating unit which calculates the correction gain such that the correction gain decreases with a decrease in the character size detected by the character size detecting unit.

With this, the image processing device performs image processing, which has a small effect, on a portion of the input image including a small character based on the feature amount. Since the image of a portion of the input image including a small character includes large image deformation caused by the enlarging processing, correction by the image processing may not be able to restore the image into the pre-enlargement state. In such a case, if the image processing device performs image processing which has a large effect, not only can the image not be restored to the pre-enlargement state but also the image deformation may further advance. By performing the image processing which has a small effect based on the feature amount instead, the image processing device prevents image deformation caused by the image processing.

Moreover, it may be that the feature amount detecting unit includes a brightness change detecting unit which detects a total number of brightness changes in the image in the character region as the feature amount, and the correction gain calculating unit calculates the correction gain such that the correction gain decreases with an increase in the total number of brightness changes detected by the brightness change detecting unit.

With this, the image processing device performs, based on the feature amount, image processing on a portion of the input image which has a large number of brightness changes when pixels are scanned in a predetermined direction, such that the image processing has a small effect. The portion having a large number of brightness changes corresponds to a portion including a small character or a portion including a character with a complicated shape such as many strokes of the character. Since such portions have large image deformation caused by the enlarging processing, correction by the image processing may not be able to restore the image into the pre-enlargement state. In such a case, if the image processing device performs image processing which has a large effect, not only can the image not be restored to the pre-enlargement state but also the image deformation may further advance. By performing the image processing which has a small effect based on the feature amount instead, the image processing device prevents image deformation caused by the image processing.

Moreover, it may be that the feature amount detecting unit detects a resolution of the input image as the feature amount, and the correction gain calculating unit calculates the correction gain such that the correction gain decreases with an increase in a difference between the resolution and a predetermined value.

With this, the image processing device performs image processing, which has a small effect, on a character region of a low-resolution input image based on the feature amount. Since such a low-resolution input image has large image deformation caused by the enlarging processing, correction by the image processing may not be able to restore the image into the pre-enlargement state. In such a case, if the image processing device performs image processing which has a large effect, not only can the image not be restored to the pre-enlargement state but also the image deformation may further advance. By performing the image processing which has a small effect instead, the image processing device prevents image deformation caused by the image processing. Enlarging processing with a small enlargement rate is performed on a high-resolution input image. Since the enlarging processing with a small enlargement rate causes small image deformation, the image processing device corrects the image deformation more appropriately by performing the image processing having a small effect.

Moreover, it may be that the feature amount detecting unit detects a bit rate of the input image as the feature amount, and the correction gain calculating unit calculates the correction gain such that the correction gain decreases with a decrease in the bit rate. With this, the image processing device performs image processing, which has a small effect, on a character region of a low bit-rate input image. Since the low bit-rate input image includes large distortion caused by compression, correction by the image processing may not be able to restore the image into the pre-enlargement state. In such a case, if the image processing device performs image processing which has a large effect, not only can the image not be restored to the pre-enlargement state but also the image deformation may further advance. By performing the image processing which has a small effect instead, the image processing device prevents image deformation caused by the image processing.

Moreover, it may be that the correcting unit corrects the input image by performing sharpening processing as the image processing.

With this, the image processing device corrects the image deformation by performing sharpening processing on the input image.

Moreover, it may be that the correcting unit performs the correction by performing noise removal processing as the image processing.

With this, the image processing device corrects the image deformation by removing noise in the input image.

Moreover, the image processing device may further include an enlarging unit which performs enlarging processing on the input image, the enlarging processing increasing a resolution of the input image, wherein the character region detecting unit detects the character region from the input image on which the enlargement processing has been performed by the enlarging unit.

With this, the image processing device receives a relatively low-resolution input image, performs enlarging processing and image processing for increasing sharpness on the received input image, and provides the input image on which the image processing has been performed.

Moreover, an image processing method according to the present disclosure includes: detecting a character region including a character from an input image; detecting a feature amount indicating a level of deformation of an image in the character region detected in the detecting of a character region; calculating a correction gain based on the feature amount detected in the detecting of a feature amount; and correcting the input image by performing image processing on the image in the character region, the image processing having an effect which decreases with a decrease in the correction gain calculated in the calculating.

With this, the advantageous effects similar to those obtained by the above image processing device can be obtained.

### Embodiment 1

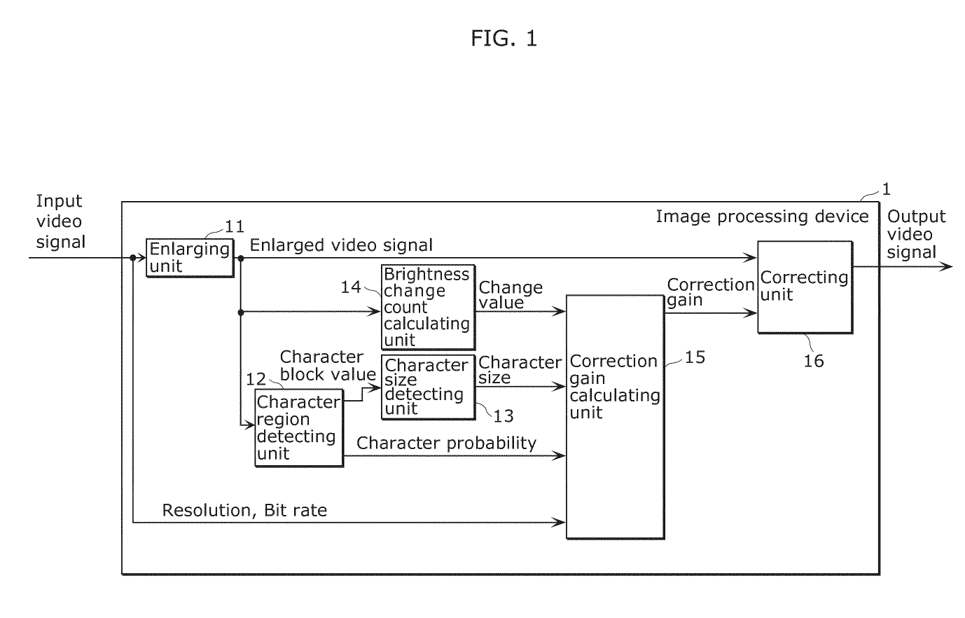

Hereinafter, Embodiment 1 will be described with reference to FIG. 1 to FIG. 17. In Embodiment 1, a description will be given of an example of an image processing device which performs image processing on a character region in an input video signal according to a feature of an image in the character region so as to increase sharpness of characters in the image. The image processing device according to Embodiment 1 is used during a process of converting a relatively low-resolution input video signal into an output video signal having a resolution higher than that of the input video signal. The resolution of the input video signal is, for example, 360 p (the number of pixels in the longitudinal direction is 360) or 480 p. The resolution of the output video signal is, for example, 1080 p (which corresponds to full high definition (FHD)).

[1-1. Configuration]

FIG. 1 is a functional block diagram of an image processing device according to Embodiment 1.

As FIG. 1 illustrates, an image processing device 1 includes an enlarging unit 11, a character region detecting unit 12, a character size detecting unit 13, a brightness change count calculating unit 14, a correction gain calculating unit 15, and a correcting unit 16.

The enlarging unit 11 enlarges an input video signal provided to the image processing device 1 by performing enlarging processing on the input video signal to increase the resolution of the input video signal, and provides the enlarged video signal thus generated. Examples of the enlarging processing include conventional techniques such as nearest neighbor, bilinear, and bicubic. The image processing device 1 need not necessarily include the enlarging unit 11. In other words, the image processing device 1 may receive an enlarged video signal from an external device having the functions similar to those of the enlarging unit 11. The input video signal may be a signal composing a still image or a signal composing a moving image. The input video signal is an example of an input image. When the input video signal is a still image, the still image corresponds to the input image. When the input video signal is a moving image, one of the frames included in the moving image corresponds to the input image. The enlarged video signal is another example of the input image.

The character region detecting unit 12 receives the enlarged video signal provided by the enlarging unit 11 and detects a character region included in the enlarged video signal. Specifically, the character region detecting unit 12 determines, for each block included in the enlarged video signal, whether or not the block includes a character. As a result of the determination, the character region detecting unit 12 calculates and provides a character block value and a character probability for each block. The character block value indicates whether or not the block includes a character. The character probability is an averaged character block value obtained in consideration with the relationship with neighboring blocks. Blocks of an enlarged video signal refers to regions obtained by dividing the enlarged video signal into plural regions. Specifically, an enlarged video signal includes plural blocks. In other words, plural blocks compose an enlarged video signal.

The character size detecting unit 13 receives the character block value provided by the character region detecting unit 12 for each block, and determines the character size of the character included in the block. The character size detecting unit 13 then provides the character size of the character in each block.

The brightness change count calculating unit 14 receives the enlarged video signal provided by the enlarging unit 11, and calculates, as a change value, the number of brightness changes in the horizontal and vertical directions in the enlarged video signal. The brightness change count calculating unit 14 provides the calculated change value.

The correction gain calculating unit 15 receives the change value provided by the brightness change count calculating unit 14, the character size provided by the character size detecting unit 13, the character probability provided by the character region detecting unit 12, and the resolution and the bit rate of the input video signal. The correction gain calculating unit 15 then calculates a degree of strength of image processing (correction gain) to be performed by the correcting unit 16 on each block. The character probability is essential out of the information items received by the correction gain calculating unit 15. The other information items are not always necessary, but such information items lead to more appropriate calculation result of the correction gain.

The correcting unit 16 performs image processing on each block of the enlarged video signal provided by the enlarging unit 11, based on the correction gain calculated by the correction gain calculating unit 15. The image processing includes smoothing or sharpening processing. The correcting unit 16 provides the signal on which the image processing has been performed, as an output video signal.

The following provides detailed descriptions of the respective functional blocks.

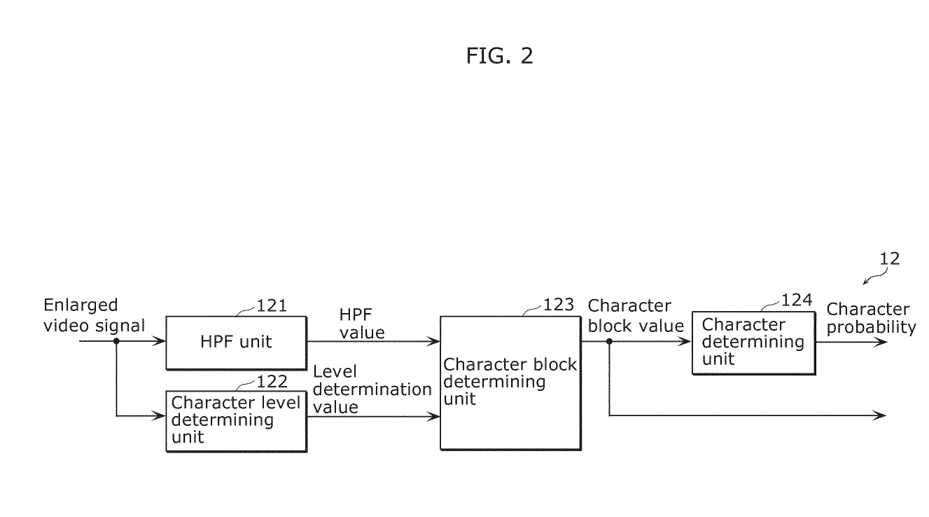

FIG. 2 is a detailed functional block diagram of the character region detecting unit 12 according to Embodiment 1.

As FIG. 2 illustrates, the character region detecting unit 12 includes: a high-pass filter (HPF) unit 121; a character level determining unit 122; a character block determining unit 123; and a character determining unit 124.

The HPF unit 121 receives the enlarged video signal provided by the enlarging unit 11 and performs unshparp masking on a per-block basis of the enlarged video signal. The HPF unit 121 provides an HPF value for each block as a result of the unsharp masking. This processing will be specifically described below.

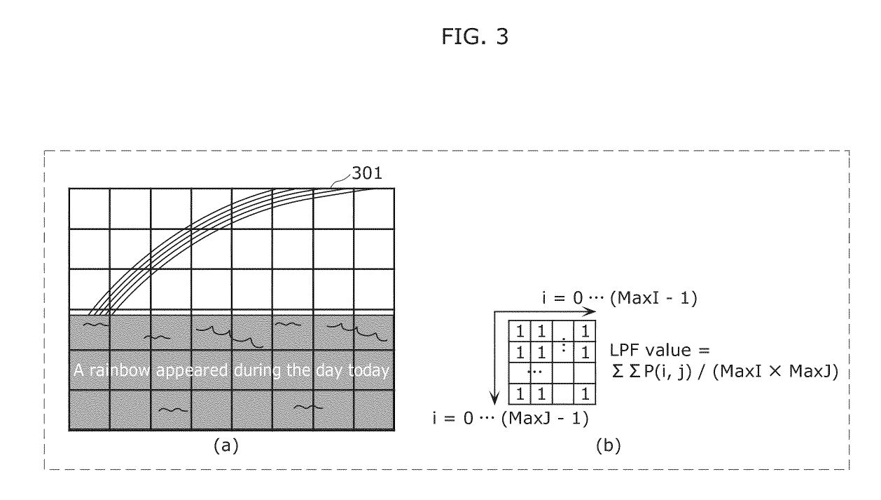

In FIG. 3, (a) illustrates an example of the enlarged video signal (enlarged video signal 301) received by the HPF unit 121. Referring to (a) of FIG. 3, processing performed by the character region detecting unit 12 will be described below. In the following description, processing is performed on each block obtained by dividing the enlarged video signal 301 into MaxI blocks in the horizontal direction and into MaxJ blocks in the vertical direction. For example, at (MaxI, MaxJ)=(32, 24), an enlarged video signal (1920×1080) of FHD is divided into 60 blocks in the horizontal direction and into 45 blocks in the vertical direction. Moreover, for example, at (MaxI, MaxJ)=(240, 180), an enlarged video signal of FHD is divided into 8 blocks in the horizontal direction and into 6 blocks in the vertical direction. With a decrease in block size, the accuracy of the determination for a region in an image in which characters are displayed increases. In the following description, a sequence of horizontally continuous blocks may be referred to as a row, and a sequence of vertically continuous blocks may be referred to as a column. The lateral direction may be referred to as a row direction or a horizontal direction, and a longitudinal direction may be referred to as a column direction or a vertical direction.

First, the HPF unit 121 calculates a low-pass filter (LPF) value for each block of the enlarged video signal 301. The LPF value refers to a value obtained by applying an LPF to a pixel of the block, and is expressed by (Equation 1). The coefficients of the LPF may be 1, for example, ((b) of FIG. 3). The coefficients of the LPF may be other than the above example.

$$\begin{matrix}[ Math . 1 ] & \\ LPF value = {\sum }_{i} {\sum }_{j} P ( i , j ) / ( Max I \times Max J ) & ( Equation 1 )\end{matrix}$$

Next, the HPF unit 121 subtracts the LPF value from a central pixel value C (the value of the central pixel in a block), obtains an absolute value of the obtained value to calculate an HPF value (Equation 2), and provides the calculated HPF value.

[Math. 2]

HPF value=|C−LPF value| (Equation 2)

The character level determining unit 122 receives the enlarged video signal 301 provided by the enlarging unit 11, and provides a level determination value which indicates an estimated level of presence of a character based on a bias of the signal level of each block of the enlarged video signal 301. This processing will be specifically described below.

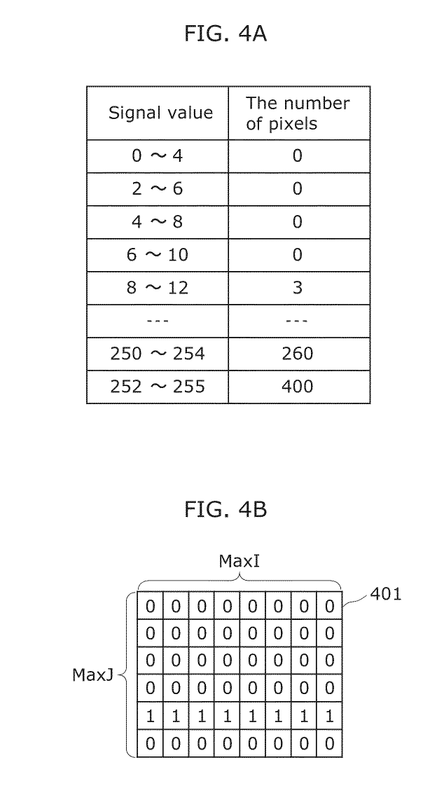

First, the character level determining unit 122 calculates the number of pixels for each signal level based on the pixel value included in each block (FIG. 4A). Here, the signal level refers to a level obtained by dividing signal values indicating brightness of a pixel value or given color component of the pixel value into plural levels each having a range. For example, in the case where brightness of a pixel value represented by 256 levels ranging from 0 to 255 is used as a signal value, a black pixel corresponds to the signal value of 0, and a white pixel corresponds to the signal value of 255. The signal level may be set in such a manner that a signal level overlaps adjacent signal levels. In other words, it may be that the first signal level includes pixels values of 0 to 4, and the second signal level includes the signal values of 2 to 6. Such a setting allows a character to be appropriately detected even if the color of the character is not strictly single, that is, when the color of the character slightly varies but substantially the same.

Next, the character level determining unit 122 counts the number of pixels belonging to each signal level, and creates a histogram indicating the number of pixels relative to the signal level. Next, the character level determining unit 122 determines whether or not there is a signal level which has the number of pixels exceeding a threshold, based on the created histogram. The character level determining unit 122 provides 1 as a level determination value when such a signal level exists, and provides 0 as the level determination value when there is no such a signal level. For example, the threshold is 300 pixels.

The character block determining unit 123 receives the HPF value provided by the HPF unit 121 and the level determination value provided by the character level determining unit 122, and provides, on a per block basis, a character block value indicating whether or not a character is included.

Specifically, the character block determining unit 123 determines, for each block, whether or not the HPF value provided by the HPF unit 121 is greater than or equal to a threshold value, and determines, for each block, whether or not the level determination value provided by the character level determining unit 122 is 1. As a result of the determination, the character block determining unit 123 provides, for each block, 1 as the character block value when the HPF value is greater than or equal to the threshold value and the level determination value is 1, and provides 0 as the character block value in other cases. For example, the character block determining unit 123 provides character block values 401 illustrated in FIG. 4B relative to the enlarged video signal 301. In FIG. 4B, the character block values of blocks are illustrated at the corresponding positions of the blocks of the enlarged video signal 301. The character block value corresponding to a block which includes a character in the enlarged video signal 301 is 1.

The character determining unit 124 receives the character block value provided by the character block determining unit 123, calculates the degree to which blocks including characters are adjacent to each other, and provides the calculated degree as the character probability. This processing will be specifically described below in detail.

Specifically, first, the character determining unit 124 calculates, for each block of the enlarged video signal 301, sum S of the character block values of nine blocks which are vertical 3 blocks and horizontal 3 blocks with the block of interest in the center. Here, the character block value of i-th block from the left in the column direction and j-th block from the top in the row direction is represented by MB (i, j).

$$\begin{matrix}[ Math . 3 ] & \\ S = {\sum }_{i} {\sum }_{j} MB ( i , j ) & ( Equation 3 )\end{matrix}$$

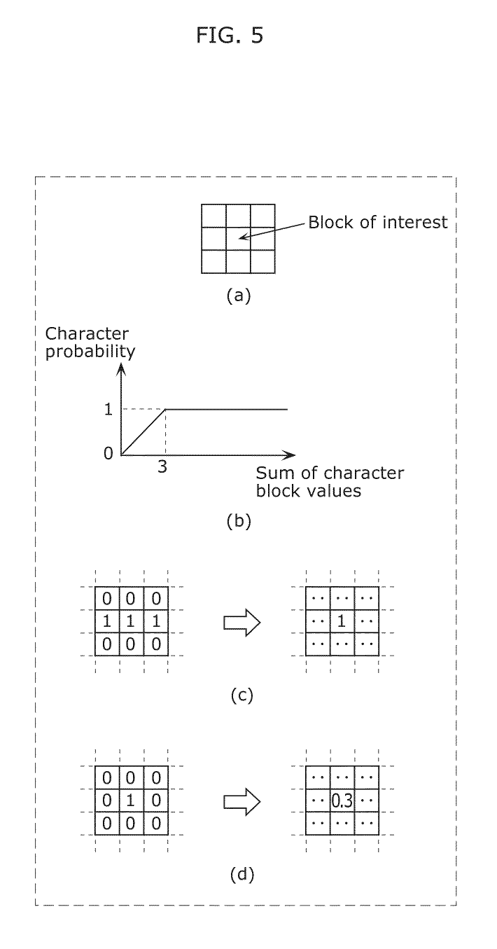

Next, the character determining unit 124 calculates the character probability based on the sum S of the character block values. The character probability refers to an increasing function relative to the sum S, and takes a value of 1 when the sum S is greater than or equal to a predetermined value. The predetermined value may be any value from 1 to 9. (b) of FIG. 5 illustrates the relationship of the character probability relative to the sum S when the predetermined value is 3. When the predetermined value is 3 and the block of interest and two or more blocks adjacent to the block of interest each have a character block value of 1, the character probability of the block of interest can be calculated as 1. In this way, as in the character block values 401, when blocks each having a character block value of 1 is continuous, the character probability of these blocks can be calculated as 1 ((c) of FIG. 5). Moreover, for example, when the block of interest has a character block value of 1 and all the blocks adjacent to the block of interest each have a character block value of 0, the character probability of the block of interest can be calculated as ⅓ (approximately 0.3) ((d) of FIG. 5). Characters in an input image are often continuous in the column direction or row direction. Hence, detection of the characters continuous in the column direction or the row direction with the above character probability allows the characters to be detected more appropriately.

The increasing function refers to a function f(x) which satisfies f(x)≦f(y) when x<y for given x and y. The decreasing function to be described later refers to a function f(x) which satisfies f(x)≧f(y) when x<y for given x and y.

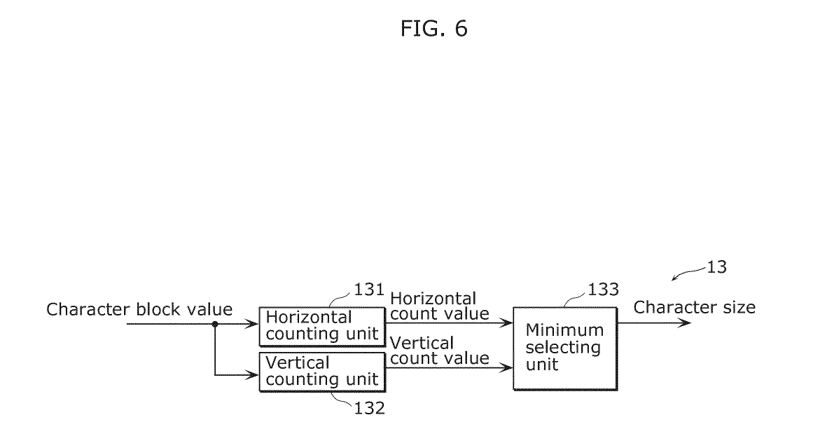

FIG. 6 is a detailed functional block diagram of the character size detecting unit 13 according to Embodiment 1.

As FIG. 6 illustrates, the character size detecting unit 13 includes a horizontal counting unit 131, a vertical counting unit 132, and a minimum selecting unit 133.

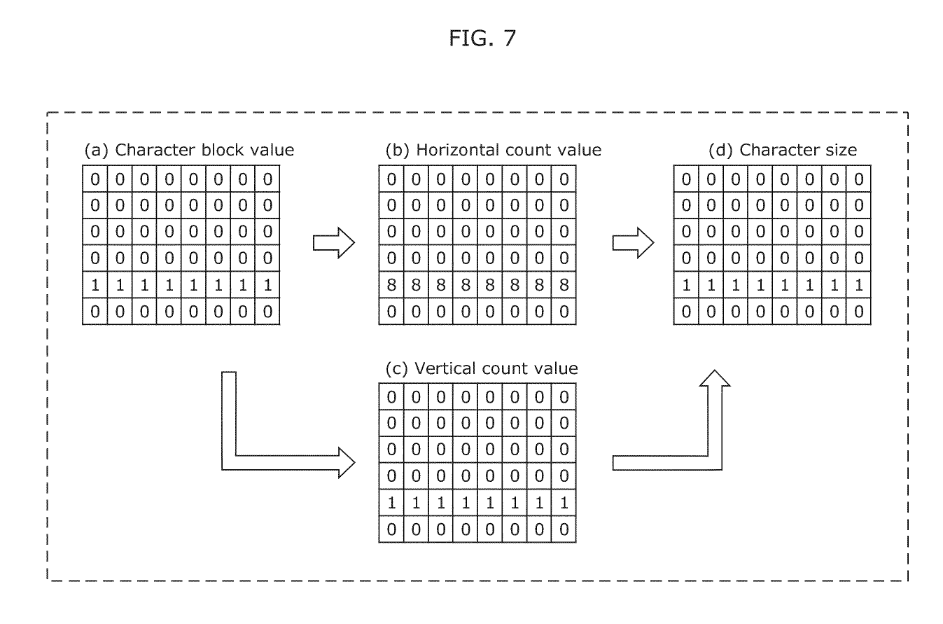

The horizontal counting unit 131 receives the character block value provided by the character block determining unit 123 in the character region detecting unit 12, and calculates and provides a horizontal count value for each block. Specifically, the horizontal counting unit 131 counts, for each block, the character block values of the blocks belonging to the same row of the block, and provides the counted value as a horizontal count value. For example, the horizontal counting unit 131 provides the horizontal count values illustrated in (b) of FIG. 7 relative to the character block values illustrated in (a) of FIG. 7 (which are the same as the character block values 401).

The vertical counting unit 132 receives the character block value provided by the character block determining unit 123 in the character region detecting unit 12, and calculates and provides a vertical count value for each block. Specifically, the vertical counting unit 132 counts, for each block, the character block values of the blocks belonging to the same column of the block, and provides the counted value as a vertical count value. For example, the vertical counting unit 132 provides the vertical count values illustrated in (c) of FIG. 7 relative to the character block values illustrated in (a) of FIG. 7 (which are the same as the character block values 401).

The minimum selecting unit 133 receives the horizontal count values provided by the horizontal counting unit 131 and the vertical count values provided by the vertical counting unit 132, selects, for each block, a smaller one of the horizontal count value and the vertical count value, and provides the value of the smaller one as a character size. For example, the minimum selecting unit 133 provides the character sizes illustrated in (d) of FIG. 7 relative to the horizontal count values illustrated in (b) of FIG. 7 and the vertical count values illustrated in (c) of FIG. 7.

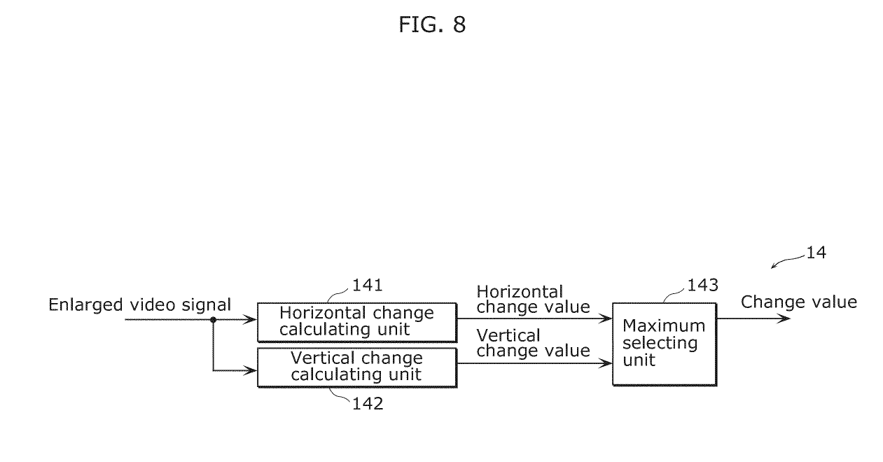

FIG. 8 is a detailed functional block diagram of the brightness change count calculating unit 14 according to Embodiment 1.

As FIG. 8 illustrates, the brightness change count calculating unit 14 includes a horizontal change calculating unit 141, a vertical change calculating unit 142, and a maximum selecting unit 143.

The horizontal change calculating unit 141 receives the enlarged video signal provided by the enlarging unit 11, and provides a horizontal change value which indicates a level of change in pixel value in the horizontal direction, on a per pixel basis. The horizontal change calculating unit 141 will be described in more detail.

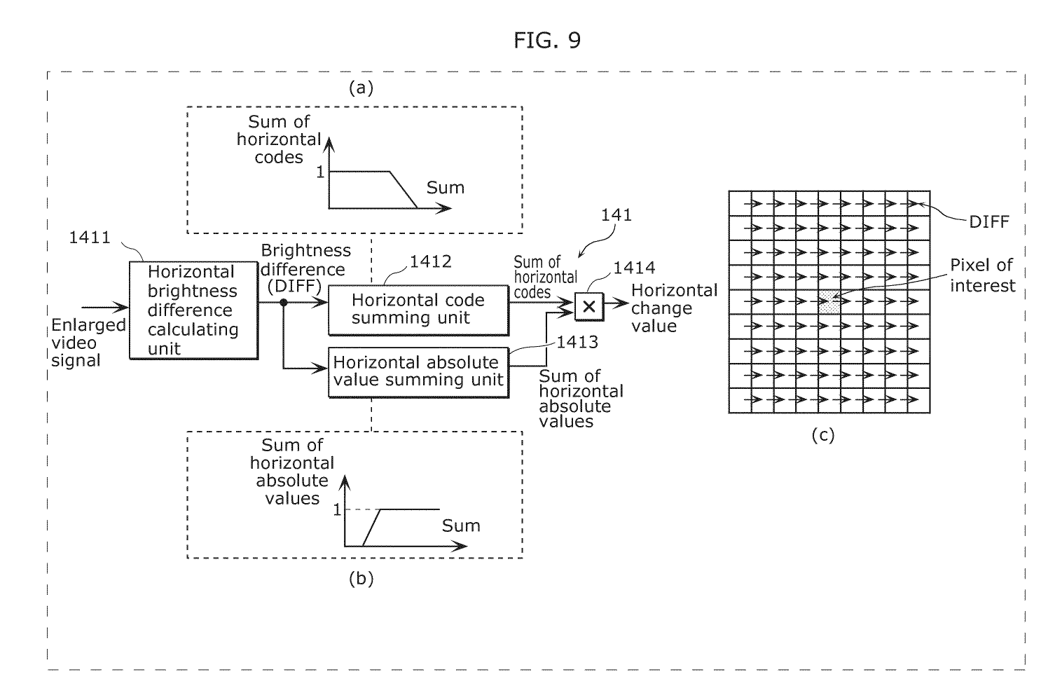

FIG. 9 is a detailed functional block diagram of the horizontal change calculating unit 141. As FIG. 9 illustrates, the horizontal change calculating unit 141 includes a horizontal brightness difference calculating unit 1411, a horizontal code summing unit 1412, a horizontal absolute value summing unit 1413, and a multiplier 1414.

The horizontal brightness difference calculating unit 1411 receives the enlarged video signal provided by the enlarging unit 11, and calculates a brightness difference DIFF from an adjacent pixel in the horizontal direction on a per pixel basis.

The horizontal code summing unit 1412 calculates and provides the sum of horizontal codes based on the brightness differences DIFFs calculated by the horizontal brightness difference calculating unit 1411. A specific description will be given referring to FIG. 9. Specifically, the horizontal code summing unit 1412 calculates, on a per-pixel basis, an absolute value D_{H,S} of the sum of the brightness differences DIFFs from adjacent pixels in a predetermined region including the pixel of interest (the pixel of interest in (c) of FIG. 9) (Equation 4). The predetermined region is, for example, a rectangle region of horizontal 9 pixels and vertical 9 pixels with the pixel of interest in the center. The predetermined region is not limited to the above rectangle region, but may be a rectangle region including any other number of pixels or a region included in any other shape such as a triangle or a circle. Additionally, the predetermined region does not always have to have the pixel of interest in the center, but may include the pixel of interest at another position.

$$\begin{matrix}[ Math . 4 ] & \\ {D}_{H , S} = \vert {\sum }_{i} {\sum }_{j} DIFF ( i , j ) \vert & ( Equation 4 )\end{matrix}$$

Next, the horizontal code summing unit 1412 calculates the sum of horizontal code S_{H,S} based on D_{H,S}. The sum of horizontal codes S_{H,S} is a decreasing function relative to D_{H,S}, and is 1 when D_{H,S} decreases and 0 when D_{H,S} increases. A specific example of the sum of horizontal codes S_{H,S} is illustrated in (a) of FIG. 9. The horizontal code summing unit 1412 provides the calculated sum of horizontal codes S_{H,S}.

The horizontal absolute value summing unit 1413 calculates and provides the sum of horizontal absolute values based on the brightness differences DIFFs calculated by the horizontal brightness difference calculating unit 1411. Specifically, the horizontal absolute value summing unit 1413 calculates, on a per-pixel basis, the sum D_{H,A} of absolute values of the brightness differences DIFFs from adjacent pixels in a predetermined region including the pixel of interest in the center (Equation 5).

$$\begin{matrix}[ Math . 5 ] & \\ {D}_{H , A} = {\sum }_{i} {\sum }_{j} \vert DIFF ( i , j ) \vert & ( Equation 5 )\end{matrix}$$

Next, the horizontal absolute value summing unit 1413 calculates the sum of horizontal absolute values S_{H,A} based on D_{H,A}. The sum of horizontal absolute values S_{H,A} is an increasing function relative to D_{H,A,} and is 0 when D_{H,A} decreases and 1 when D_{H,A} increases. A specific example of the sum of horizontal absolute values S_{H,A} is illustrated in (b) of FIG. 9. The horizontal absolute value summing unit 1413 provides the calculated sum of horizontal absolute values S_{H,A}.

The multiplier 1414 receives the sum of horizontal codes provided by the horizontal code summing unit 1412 and the sum of horizontal absolute values provided by the horizontal absolute value summing unit 1413, and provides a product of the sum of horizontal codes and the sum of horizontal absolute values as a horizontal change value. The horizontal change value is an output from the horizontal change calculating unit 141.

Returning to FIG. 8, the vertical change calculating unit 142 receives the enlarged video signal provided by the enlarging unit 11, and provides, on a per-pixel basis, a vertical change value indicating a level of change in pixel value in the vertical direction. The vertical change calculating unit 142 will be described in more detail.

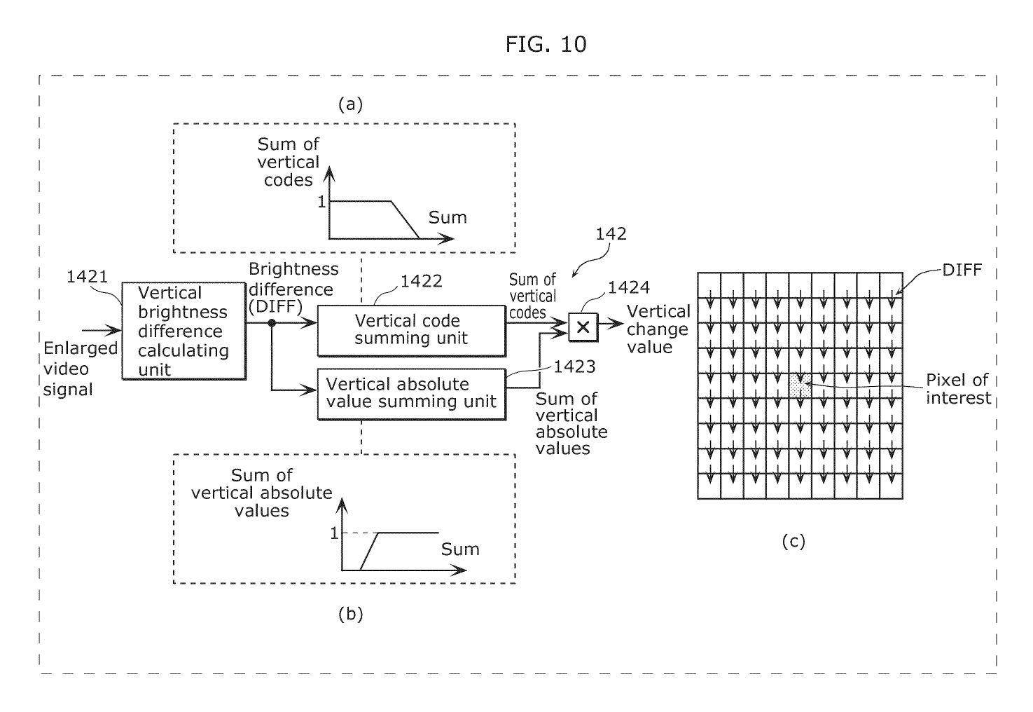

FIG. 10 is a detailed functional block diagram of the vertical change calculating unit 142. As FIG. 10 illustrates, the vertical change calculating unit 142 includes a vertical brightness difference calculating unit 1421, a vertical code summing unit 1422, a vertical absolute value summing unit 1423, and a multiplier 1424.

The vertical brightness difference calculating unit 1421 receives the enlarged video signal provided by the enlarging unit 11, and calculates a brightness difference DIFF from an adjacent pixel in the vertical direction on a per-pixel basis.

The vertical code summing unit 1422 calculates and provides the sum of vertical codes based on the brightness differences DIFFs calculated by the vertical brightness difference calculating unit 1421. A specific calculating method is similar to the method performed by the horizontal code summing unit 1412 to calculate the sum of horizontal codes. The vertical code summing unit 1422 calculates the sum of vertical codes S_{v,S} based on D_{v,S} which is the sum of the absolute values of the brightness differences DIFFs from adjacent pixels.

$$\begin{matrix}[ Math . 6 ] & \\ {D}_{V , S} = \vert {\sum }_{i} {\sum }_{j} DIFF ( i , j ) \vert & ( Equation 6 )\end{matrix}$$

The vertical absolute value summing unit 1423 calculates the sum of vertical absolute values based on the brightness differences DIFFs calculated by the vertical brightness difference calculating unit 1421. A specific calculating method is similar to the method performed by the horizontal absolute value summing unit 1413 to calculate the sum of horizontal absolute values. The vertical absolute value summing unit 1423 calculates the sum of vertical codes S_{V,A} based on D_{V,A} (Equation 7) which is the absolute values of brightness differences DIFFs from adjacent pixels.

$$\begin{matrix}[ Math . 7 ] & \\ {D}_{V , A} = {\sum }_{i} {\sum }_{j} \vert DIFF ( i , j ) \vert & ( Equation 7 )\end{matrix}$$

The multiplier 1424 receives the sum of vertical codes provided by the vertical code summing unit 1422 and the sum of vertical absolute values provided by the vertical absolute value summing unit 1423, and provides, as a vertical change value, a product of the sum of vertical codes and the sum of vertical absolute values. The vertical change value is an output from the vertical change calculating unit 142.

Returning to FIG. 8, the maximum selecting unit 143 receives the horizontal change value provided by the horizontal change calculating unit 141 and the vertical change value provided by the vertical change calculating unit 142, and provides, on a per-pixel basis, a larger one of the horizontal change value and the vertical change value as a change value.

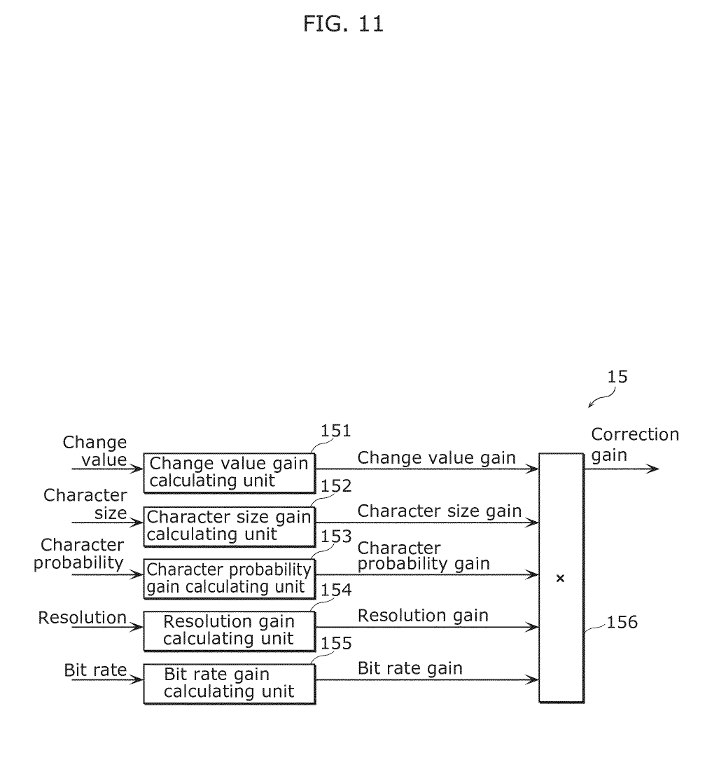

FIG. 11 is a detailed functional block diagram of the correction gain calculating unit 15 according to Embodiment 1. As FIG. 11 illustrates, the correction gain calculating unit 15 includes a change value gain calculating unit 151, a character size gain calculating unit 152, a character probability gain calculating unit 153, a resolution gain calculating unit 154, a bit rate gain calculating unit 155, and a multiplier 156. The character probability gain calculating unit 153 and the multiplier 156 are essential structural elements. At least one of the change value gain calculating unit 151, the character size gain calculating unit 152, the character probability gain calculating unit 153, the resolution gain calculating unit 154, or the bit rate gain calculating unit 155 may be included.

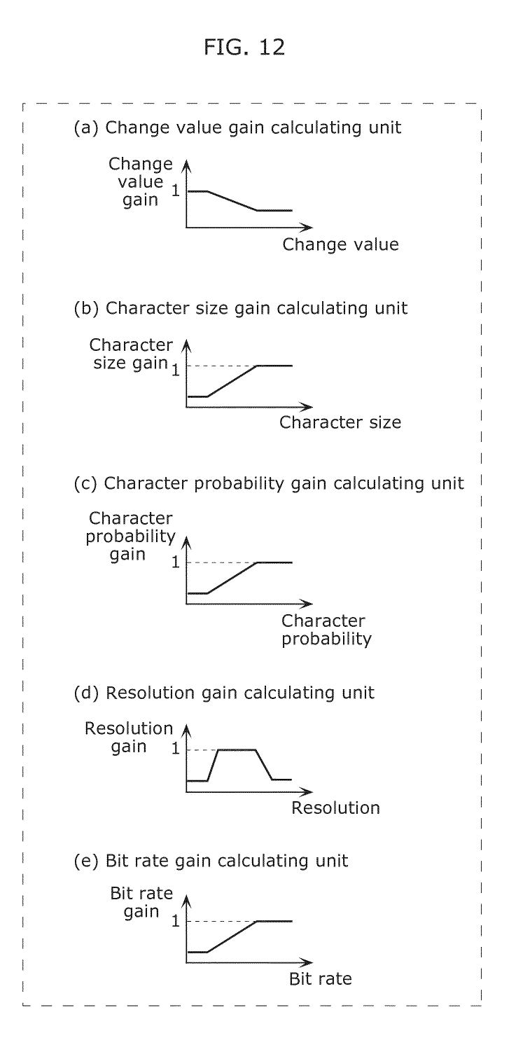

The change value gain calculating unit 151 receives the change value provided by the brightness change count calculating unit 14, and calculates and provides a change value gain based on the change value. Specifically, the change value gain calculating unit 151 calculates a change value gain such that the change value gain decreases with an increase in change value. The change value gain takes a value of 0 or greater and 1 or less. An example of a function of the change value gain relative to a change value is illustrated in (a) of FIG. 12.

With such configuration, the correction gain of the image processing can be reduced for a portion of the input video signal which has a large amount of brightness change. The change value provided by the brightness change count calculating unit 14 increases for a pixel which includes a larger amount of brightness change from neighboring pixels. It is known that such a pixel having a large brightness change and its neighboring portion are significantly degraded due to compression noise (image deformation of a character is large). Performing image processing (sharpening processing) on such portions causes the compression noise to be noticeable or causes further deformation of the image. Accordingly, reducing the correction gain for the image processing performed on such portions prevents the compression noise from being noticeable.

Returning to FIG. 11, the character size gain calculating unit 152 receives the character size provided by the character size detecting unit 13, and calculates and provides a character size gain based on the received character size. Specifically, the character size gain calculating unit 152 calculates the character size gain such that the character size gain increases with an increase in character size. The character size gain takes a value of 0 or greater and 1 or less. An example of a function of the character size gain relative to a character size is illustrated in (b) of FIG. 12.

With such configuration, it is possible to reduce the correction gain of the image processing performed on a portion of the input video signal which includes a small character. The character size provided by the character size detecting unit 13 takes a small value in a block including a small character. It is known that such a portion including a small character is significantly degraded due to compression noise (image deformation of a character is large). Performing image processing (sharpening processing) on such a portion causes the compression noise to be noticeable. On the other hand, a portion including a large character is often prepared by a provider of the input video signal to emphasize the character. Moreover, it is known that image processing (sharpening processing) sharpens such a portion including a large character more appropriately. Accordingly, reduction in correction gain for image processing performed on a portion including a small character prevents the compression noise from being noticeable, and increase in correction gain for image processing performed on a portion including a large character facilitates legibility of the large character.

Returning to FIG. 11, the character probability gain calculating unit 153 receives the character probability provided by the character region detecting unit 12, and calculates and provides a character probability gain based on the character probability. Specifically, the character probability gain calculating unit 153 calculates the character probability such that the character probability decreases with a decrease in character probability. The character probability gain takes a value of 0 or greater and 1 or less. An example of a function of the character probability gain relative to a character probability is illustrated in (c) of FIG. 12.

With such configuration, the correction gain can be increased for a portion of the input video signal estimated to include a character, and the correction gain can be reduced for a portion estimated to include no character. The character probability provided by the character region detecting unit 12 takes a large value in a block estimated to include a character (for example, 1 in the right figure of (c) in FIG. 5), and takes a small value in a block other than the above (for example, 0.1 in the right figure of (d) in FIG. 5). Increase in correction gain of the image processing performed on a portion including a character facilitates visibility of the character.

Returning to FIG. 11, the resolution gain calculating unit 154 receives the resolution of the input video signal, and calculates and provides a resolution gain based on the resolution. Specifically, the resolution gain calculating unit 154 calculates the resolution gain such that the resolution gain decreases with an increase in deviation of the resolution from a predetermined value or with a decrease in deviation of the resolution from the predetermined value. In other words, the resolution gain calculating unit 154 calculates the resolution gain such that the resolution gain decreases with an increase in difference between the resolution and the predetermined value. The resolution gain takes a value of 0 or greater and 1 or less. An example of a function of the resolution gain relative to a resolution is illustrated in (d) of FIG. 12.

With such configuration, the correction gain can be reduced for an input video signal having a resolution greater than a predetermined value. The effects of enlarging processing performed by the enlarging unit 11 decrease with an increase in resolution of the input video signal. Since image distortion caused by enlarging processing performed on an input video signal having a resolution greater than a predetermined value is small (image deformation of a character is small), the correction gain of the image processing is reduced. Moreover, with the calculation of the correction gain in the above manner, the correction gain can be reduced for an input video signal having a resolution less than a predetermined value. The effects of enlarging processing performed by the enlarging unit 11 increase with a decrease in resolution of the input video signal. Image distortion caused by enlarging processing performed on an input video signal having a resolution less than a predetermined value is large (image deformation of a character is large). When the image distortion is too large, the detailed structure of a character is lost (character shape is deformed). In such a case, since increase in sharpness of the character by image processing is not desired, the correction gain of the image processing is reduced.

Returning to FIG. 11, the bit rate gain calculating unit 155 receives the bit rate of the input video signal, and calculates and provides a bit rate gain based on the bit rate. Specifically, the bit rate gain calculating unit 155 calculates the bit rate gain such that the bit rate gain decreases with a decrease in bit rate. The bit rate gain takes a value of 0 or greater and 1 or less. An example of a function of the bit rate gain relative to a bit rate is illustrated in (e) of FIG. 12. In the case where the input video signal is a moving image, each frame included in the moving image may have different bit rates. In such a case, the bit rate of the frame to be processed may be used.

With such configuration, the correction gain for the image processing performed on a low bit-rate input video signal can be reduced. The low bit-rate input video signal includes a large amount of compression noise caused at the time of generation of the input signal, and has been significantly degraded (including large deformation of the character). In such a case, since increase in sharpness of the character by image processing is not desired, the correction gain of the image processing is reduced.

Returning to FIG. 11, the multiplier 156 provides, as a correction gain, a product of the change value gain, the character size gain, the character probability gain, the resolution gain, and the bit rate gain.

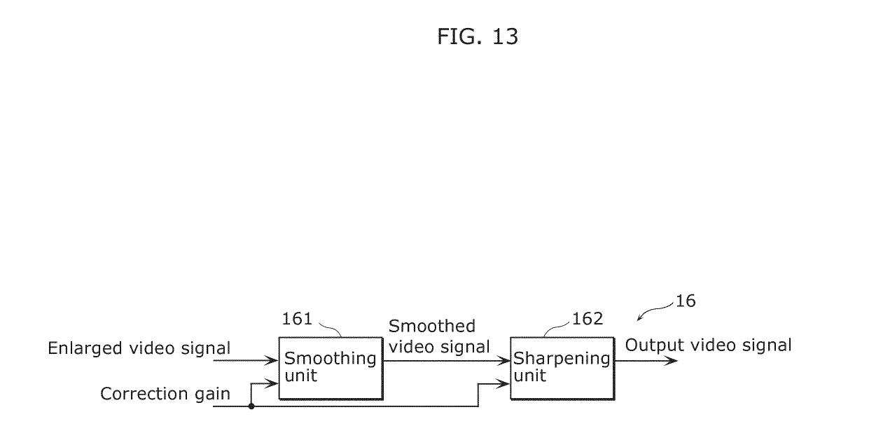

FIG. 13 is a detailed functional block diagram of the correcting unit 16 according to Embodiment 1. As FIG. 13 illustrates, the correcting unit 16 includes a smoothing unit 161 and a sharpening unit 162.

The smoothing unit 161 receives the enlarged video signal generated by the enlarging unit 11 and the correction gain calculated by the correction gain calculating unit 15. The smoothing unit 161 smoothes the enlarged video signal to generate and provide a smoothed video signal. The smoothing unit 161 will be further described in detail.

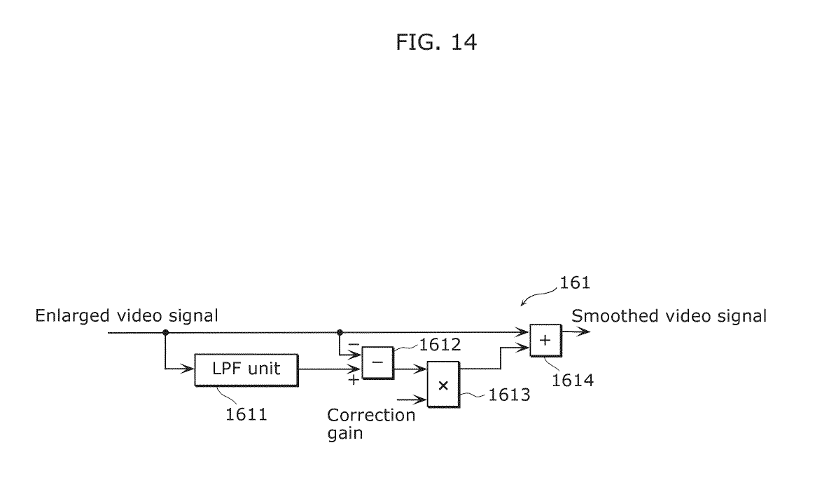

FIG. 14 is a detailed functional block diagram of the smoothing unit 161. As FIG. 14 illustrates, the smoothing unit 161 includes a low-pass filter (LPF) unit 1611, a subtractor 1612, a multiplier 1613, and an adder 1614.

The LPF unit 1611 applies an LPF to the enlarged video signal, and provides the signal thus obtained.

The subtractor 1612 subtracts the enlarged video signal from the signal obtained by the LPF unit through application of the LPF to the enlarged video signal, and provides the signal thus obtained.

The multiplier 1613 calculates and provides a product of the signal provided by the subtractor 1612 and the correction gain calculated by the correction gain calculating unit 15.

The adder 1614 adds the enlarged video signal and the signal provided by the multiplier 1613, and provides the signal thus obtained as a smoothed video signal.

With such configuration, the smoothing unit 161 provides the enlarged video signal as it is as a smoothed video signal when the correction gain is 0. When the correction gain is 1, the smoothing unit 161 provides the smoothed enlarged video signal as a smoothed video signal. When the correction gain is a value between 0 and 1, the smoothing unit 161 provides, as the smoothed video signal, the enlarged video signal smoothed in a higher level with an increase in correction gain.

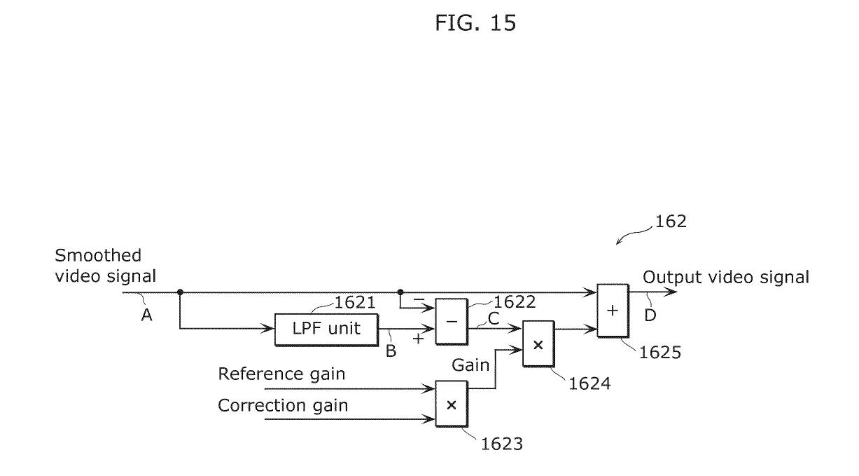

FIG. 15 is a detailed functional block diagram of the sharpening unit 162. The processing illustrated in FIG. 15 is an example of unsharp masking.

As FIG. 15 illustrates, the sharpening unit 162 includes an LPF unit 1621, a subtractor 1622, a multiplier 1623, a multiplier 1624, and an adder 1625.

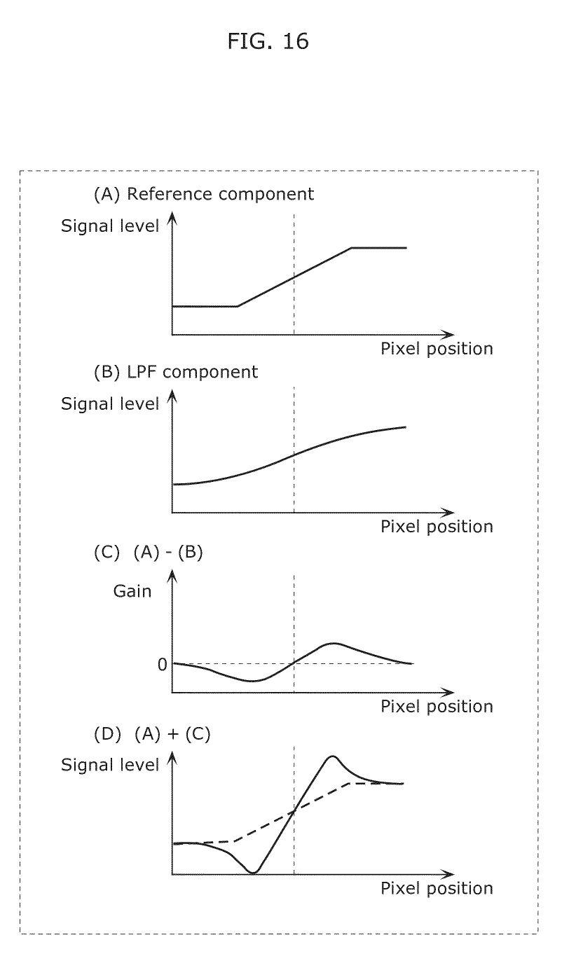

The LPF unit 1621 applies an LPF to a smoothed video signal A ((A) in FIG. 16), and provides a signal B ((B) in FIG. 16) thus obtained.

The subtractor 1622 subtracts the enlarged video signal from the signal provided by the LPF unit 1621, and provides a signal C ((C) in FIG. 16) thus obtained.

The multiplier 1623 calculates a product of a reference gain and a correction gain, and provides the calculated product as a gain. Here, the reference gain refers to a numerical value serving as a reference for the level of sharpening processing (level of the effects). In other words, higher level sharpening processing (which produces larger effects) is performed with an increase in reference gain. The reference gain is a preset value, and may be 3, for example.

The multiplier 1624 calculates and provides a product of the signal provided by the subtractor 1622 and the gain.

The adder 1625 adds the smoothed video signal and the signal provided by the multiplier 1624, and provides the signal thus obtained as an output video signal D ((D) in FIG. 16).

With such configuration, when the correction gain is 0, the sharpening unit 162 provides the enlarged video signal as it is as an output video signal. The sharpening unit 162 provides the signal obtained by sharpening the enlarged video signal with the level indicated by the reference gain as the output video signal, when the correction gain is 1. When the correction gain is a value between 0 and 1, the sharpening unit 162 provides, as the smoothed video signal, the enlarged video signal sharpened in a higher level with an increase in correction gain. In other words, the correction gain serves as a value which adjusts the level of the sharpening processing between the reference gain and 0.

The example has been described above where the correction gain calculating unit 15 calculates the correction gain based on the resolution of the input video signal. However, the enlargement rate in the enlarging processing performed by the enlarging unit 11 may be used instead of the resolution. The resolution and the enlargement rate have an inverse relationship. When the enlargement rate is used instead of the resolution and a component of the correction gain for the enlargement rate is an enlargement rate gain, the correction gain calculating unit 15 calculates the enlargement rate gain such that the enlargement rate gain decreases with an increase in deviation of the enlargement rate from a predetermined value or with a decrease of deviation of the enlargement rate from the predetermined value. In other words, the correction gain calculating unit 15 calculates the enlargement rate gain such that the enlargement rate gain decreases with an increase in difference between the enlargement rate and the predetermined value.

[1-2. Operation]

An operation of the image processing device 1 thus configured will be described below.

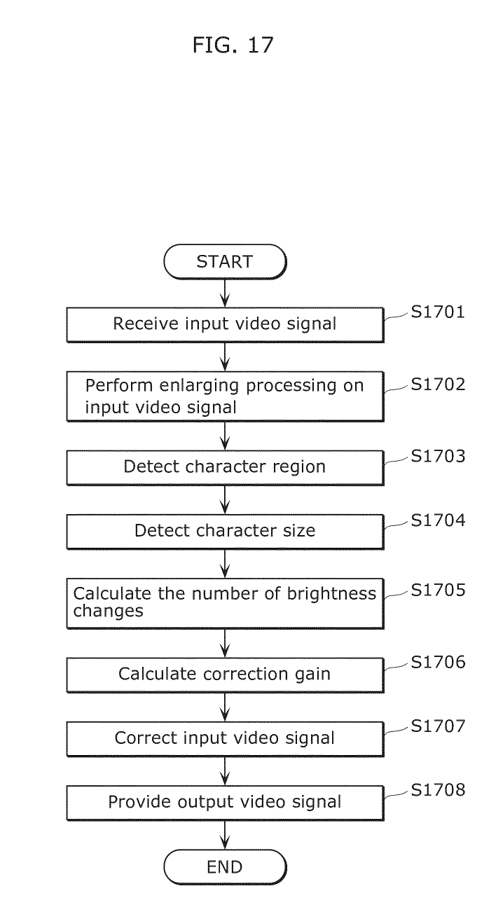

FIG. 17 is a flowchart of the image processing device 1 according to Embodiment 1. The operation and the processing of the image processing device 1 will be described below in detail.

In Step S1701, the image processing device 1 receives an input video signal.

In Step S1702, the enlarging unit 11 performs enlarging processing on the input video signal received by the image processing device in Step S1701. The enlarging unit 11 is not an essential structural element. In the case where the image processing device 1 does not include the enlarging unit 11, the processing in Step S1702 is not performed. In such a case, the image processing device 1 obtains an enlarged video signal from an external device having functions substantially the same as the enlarging unit 11.

In Step S1703, the character region detecting unit 12 receives the enlarged video signal, and detects a character region included in the enlarged video signal. The character region detecting unit 12 calculates and provides a character block value and a character probability.

In Step S1704, the character size detecting unit 13 receives the character block value provided by the character region detecting unit 12 in Step S1703, and determines the character size of a character included in each block. The text size detecting unit 13 provides the text size of the character included in each block.

In Step S1705, the brightness change count calculating unit 14 receives the enlarged video signal provided by the enlarging unit 11 in Step S1702, and calculates, as a change value, the number of brightness changes in the horizontal and vertical directions in the enlarged video signal. The brightness change count calculating unit 14 provides the calculated change value. Step S1705 need not be necessarily executed after S1704, but may be executed after the completion of the processing in S1702.

In Step S1706, the correction gain calculating unit 15 receives the change value provided by the brightness change count calculating unit 14 in Step S1705, the character size provided by the character size detecting unit 13 in Step S1704, the character probability provided by the character region detecting unit 12 in Step S1703, the resolution and the bit rate of the input video signal received in Step S1701. The correction gain calculating unit 15 then calculates the level of the image processing performed by the correcting unit 16 on each block (correction gain).

In Step S1707, the correcting unit 16 performs image processing on each block of the enlarged video signal based on the correction gain calculated by the correction gain calculating unit 15. Here, the enlarged video signal is a signal generated by the enlarging unit 11 through enlargement of the input video signal in Step S1702. In the case where the image processing device 1 does not include the enlarging unit 11, the enlarged video signal is a signal obtained from an external device.

In Step S1708, the image processing device 1 provides an output video signal provided by the correcting unit 16 in Step S1707.

[1-3. Effects]

As described above, the image processing device according to Embodiment 1 performs, on a character region in an input image, image processing which increases the sharpness according to the feature mount (image processing which has an effect according to the feature amount). The feature amount indicates the level of deformation of an image in the character region caused by the enlarging processing performed on the input image. Hence, the image processing device corrects the image deformation appropriately by performing image processing based on the feature amount. Accordingly, the image processing device increases sharpness of the characters in an image.

Moreover, the image processing device performs image processing, which has a small effect, on a portion of the input image including a small character. Since the image of a portion of the input image including a small character includes large image deformation caused by the enlarging processing, correction by the image processing may not be able to restore the image into the pre-enlargement state. In such a case, if the image processing device performs image processing which has a large effect, not only can the image not be restored to the pre-enlargement state but also the image deformation may further advance. By performing the image processing which has a small effect instead, the image processing device prevents image deformation caused by the image processing.

Moreover, the image processing device performs image processing, which has a small effect, on a portion of an input image which has a large number of brightness changes when pixels are scanned in a predetermined direction. The portion having a large number of brightness changes corresponds to a portion including a small character or a portion including a character with a complicated shape such as many strokes of the character. Since such portions have large image deformation caused by the enlarging processing, correction by the image processing may not be able to restore the image into the pre-enlargement state. In such a case, if the image processing device performs image processing which has a large effect, not only can the image not be restored to the pre-enlargement state but also image deformation may further advance. By performing the image processing which has a small effect instead, the image processing device prevents image deformation caused by the image processing.

Moreover, the image processing device performs image processing, which has a small effect, on a character region of a low-resolution input image. Since such a low-resolution input image has large image deformation caused by the enlarging processing, correction by the image processing may not be able to restore the image into the pre-enlargement state. In such a case, if the image processing device performs image processing which has a large effect, not only can the image not be restored to the pre-enlargement state but also image deformation may further advance. By performing the image processing which has a small effect instead, the image processing device prevents image deformation caused by the image processing. Enlarging processing with a small enlargement rate is performed on a high-resolution input image. Since the enlarging processing with a small enlargement rate causes small image deformation, the image processing device corrects the image deformation appropriately by performing the image processing having a small effect.

Moreover, the image processing device performs image processing, which has a small effect, on a character region of a low bit-rate input image. Since the low bit-rate input image includes large distortion caused by compression, correction by the image processing may not be able to restore the image into the pre-enlargement state. In such a case, if the image processing device performs image processing which has a large effect, not only can the image not be restored to the pre-enlargement state but also image deformation may further advance. By performing the image processing which has a small effect instead, the image processing device prevents image deformation caused by the image processing.

Moreover, the image processing device corrects image deformation by performing sharpening processing on the input image.

Moreover, the image processing device corrects the image deformation by removing noise in the input image.

Moreover, the image processing device receives a relatively low-resolution input image, performs enlarging processing and image processing which increases sharpness on the received input image, and provides the input image on which the image processing has been performed.

### Embodiment 2

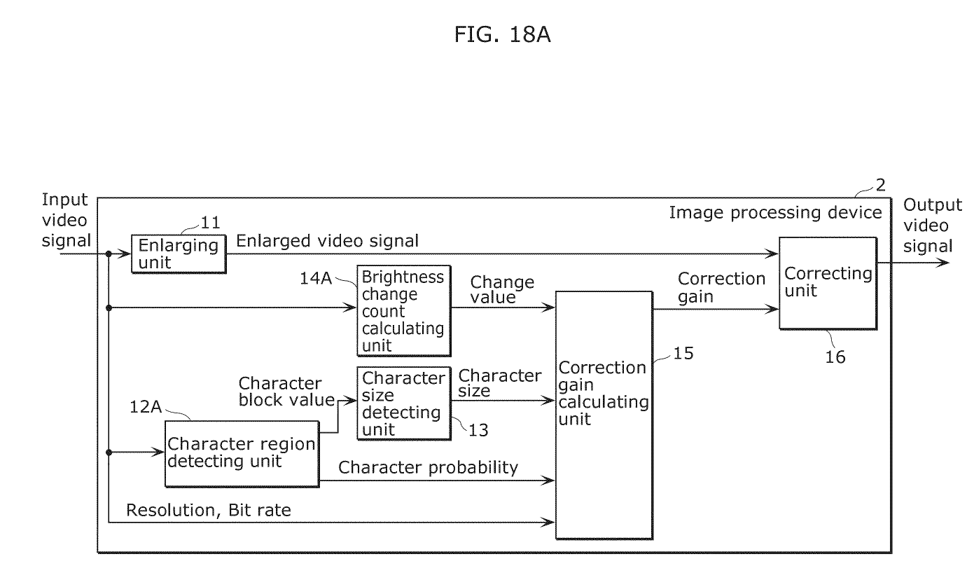

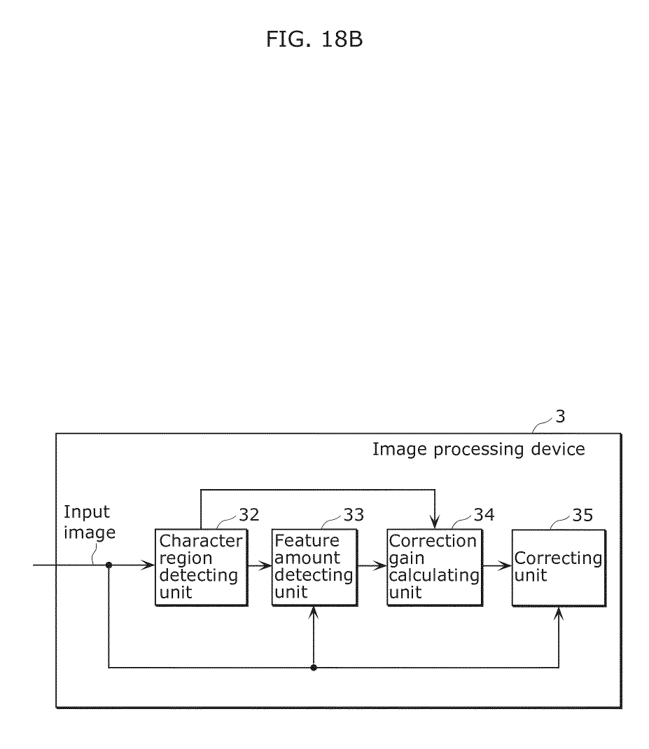

Hereinafter, Embodiment 2 will be described with reference to FIG. 18A. The character region detecting unit 12 and the brightness change count calculating unit 14 in the image processing device 1 according to Embodiment 1 performs processing based on an enlarged video signal. In Embodiment 2, a description will be given of an example of an image processing device where the functional blocks corresponding to the character region detecting unit 12 and the brightness change count calculating unit 14 perform processing based on an input video signal.

[2-1. Configuration]

FIG. 18A is a functional block diagram of an image processing device 2 according to Embodiment 2. As FIG. 18A illustrates, the image processing device 2 according to Embodiment 2 includes a character region detecting unit 12A and a brightness change count calculating unit 14A. The other functional blocks are similar to those in the image processing device 1 according to Embodiment 1, and thus, the detailed description thereof is not given.

The character region detecting unit 12A receives the input video signal received by the image processing device 2, and detects a character region included in the input video signal. Specifically, the character region detecting unit 12A determines, for each block included in the input video signal, whether or not the block includes a character. As a result of the determination, the character region detecting unit 12A calculates and provides a character block value and a character probability for each block. The character block value indicates whether or not the block includes a character. The character probability is an averaged value of the character block value obtained in consideration with the relationship with neighboring blocks.

The brightness change count calculating unit 14A receives the input video signal received by the image processing device 2, and calculates, as a change value, the number of brightness changes in the horizontal and vertical directions in the input video signal. The brightness change count calculating unit 14A provides the calculated change value.

[2-2. Operation]

The operation of the image processing device 2 thus configured will be described below.

Step S1703 and Step S1705 in the operation of the image processing device 1 are replaced with corresponding steps, Step S1703A and Step S1705A, in the operation of the image processing device 2. Step S1703A and Step S1705A will be described below.

Step S1703A corresponds to Step S1703 performed by the image processing device 1. In Step S1703A, the character region detecting unit 12A receives the input video signal, and detects a character region included in the input video signal. The character region detecting unit 12A calculates and provides a character block value and a character probability.

Step S1705A corresponds to Step S1705 performed by the image processing device 1. In Step S1705A, the brightness change count calculating unit 14A receives the input video signal in Step S1702, and calculates, as a change value, the number of brightness changes in the horizontal and vertical directions in the input video signal. The brightness change count calculating unit 14A provides the calculated change value. Step S1705A need not be necessarily executed after Step S1704, but may be executed after the completion of the processing in Step S1702.

[2-3. Effects]

In such a manner, the correction gain calculating unit 15 calculates a correction gain based on an input video signal, and the correcting unit 16 performs image processing on the enlarged video signal based on the calculated correction gain. The enlarging processing performed by the enlarging unit 11 may cause not only a difference in resolution between the input video signal and the enlarged video signal, but also a difference in pixel value (blur) due to pixel interpolation. In such a case, image processing performed based on the correction gain calculated based on the input video image increases sharpness of the characters more appropriately.

### Variation of Embodiment 2

Hereinafter, Variation of Embodiment 2 will be described with reference to FIG. 18B. The structural elements included in an image processing device 3 according to Variation of Embodiment 2 are the structural elements essential in the image processing device 1 according to Embodiment 1 or the image processing device 2 according to Embodiment 2.

[3-1. Configuration]

FIG. 18B is a functional block diagram of the image processing device 3 according to Variation of Embodiment 2. As FIG. 18B illustrates, the image processing device 3 according to Variation of Embodiment 2 includes a character region detecting unit 32, a feature amount detecting unit 33, a correction gain calculating unit 34, and a correcting unit 35.

The character region detecting unit 32 detects a character region including a character from an input image. The character region detecting unit 32 corresponds to the character region detecting unit 12.

The feature amount detecting unit 33 detects the feature amount indicating the level of image deformation in the character region detected by the character region detecting unit 32. The feature amount detecting unit 33 corresponds to the character size detecting unit 13 or the brightness change count calculating unit 14.

The correction gain calculating unit 34 calculates a correction gain for the character region detected by the character region detecting unit 32, based on the feature amount detected by the feature amount detecting unit 33. The correction gain calculating unit 34 corresponds to the correction gain calculating unit 15.

The correcting unit 35 corrects the input signal by performing image processing on the image in the character region, such that the image processing has an effect which decreases with a decrease in correction gain calculated by the correction gain calculating unit 34. The correcting unit 35 corresponds to the correcting unit 16.

[3-2. Effects]

The image processing device 3 according to Variation of Embodiment 2 has the effects similar to those of Embodiment 1 or Embodiment 2.

### Other Embodiments

Each embodiment has been described above as an example of a technique disclosed by the present application.

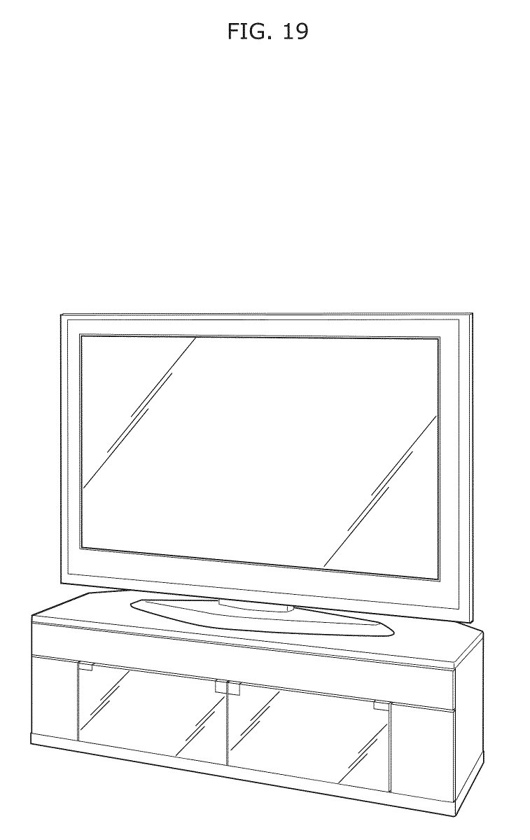

The image processing device according to each embodiment is mounted in, for example, a television (FIG. 19), a video recording device, a set top box, and a personal computer (PC).

The technique according to the present disclosure is not limited to the above examples, but is applicable to embodiments to which modifications, changes, replacements, additions, and omissions are made. Moreover, the structural elements described in the above Embodiments 1 and 2 may be combined into a new embodiment.

Embodiments have been described above as examples of a technique disclosed in the present disclosure. For this purpose, the accompanying drawings and detailed descriptions have been provided.

Thus, the structural elements set forth in the accompanying drawings and detailed descriptions include not only structural elements essential for solving the problems but also structural elements not essential for solving the problems to illustrate the examples of the above embodiments. Thus, those not essential structural elements should not be acknowledged essential due to the mere fact that the not essential structural elements are described in the accompanying drawings and the detailed descriptions.

The above embodiments illustrate examples of the technique according to the present disclosure, and thus various changes, replacements, additions and omissions are possible in the scope of the appended claims and the equivalents thereof.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present disclosure is applicable to an image processing device which receives an input video signal with a relatively low resolution and provides an output video signal with a resolution higher than that of the input video signal. Specifically, the present disclosure is applicable to a television, a video recording device, a set top box, a PC, and the like.

1. An image processing device comprising:
a character region detecting unit configured to detect a character region including a character from an input image;
a feature amount detecting unit configured to detect a feature amount indicating a level of deformation of an image in the character region detected by the character region detecting unit;
a correction gain calculating unit configured to calculate a correction gain based on the feature amount detected by the feature amount detecting unit; and
a correcting unit configured to correct the input image by performing image processing on the image in the character region, the image processing having an effect which decreases with a decrease in the correction gain calculated by the correction gain calculating unit.

2. The image processing device according to claim 1,
wherein the feature amount detecting unit includes
a character size detecting unit configured to detect a character size as the feature amount, the character size being a size of the character in the character region, and
the correction gain calculating unit is configured to calculate the correction gain such that the correction gain decreases with a decrease in the character size detected by the character size detecting unit.

3. The image processing device according to claim 1,
wherein the feature amount detecting unit includes
a brightness change detecting unit configured to detect a total number of brightness changes in the image in the character region as the feature amount, and
the correction gain calculating unit is configured to calculate the correction gain such that the correction gain decreases with an increase in the total number of brightness changes detected by the brightness change detecting unit.

4. The image processing device according to claim 1,
wherein the feature amount detecting unit is configured to detect a resolution of the input image as the feature amount, and
the correction gain calculating unit is configured to calculate the correction gain such that the correction gain decreases with an increase in a difference between the resolution and a predetermined value.

5. The image processing device according to claim 1, wherein the feature amount detecting unit is configured to detect a bit rate of the input image as the feature amount, and the correction gain calculating unit is configured to calculate the correction gain such that the correction gain decreases with a decrease in the bit rate.

6. The image processing device according to claim 1,
wherein the correcting unit is configured to correct the input image by performing sharpening processing as the image processing.

7. The image processing device according to claim 1,
wherein the correcting unit is configured to perform the correction by performing noise removal processing as the image processing.

8. The image processing device according to claim 1, further comprising
an enlarging unit configured to perform enlarging processing on the input image, the enlarging processing increasing a resolution of the input image,
wherein the character region detecting unit is configured to detect the character region from the input image on which the enlarging processing has been performed by the enlarging unit.

9. An image processing method comprising:
detecting a character region including a character from an input image;
detecting a feature amount indicating a level of deformation of an image in the character region detected in the detecting of a character region;
calculating a correction gain based on the feature amount detected in the detecting of a feature amount; and
correcting the input image by performing image processing on the image in the character region, the image processing having an effect which decreases with a decrease in the correction gain calculated in the calculating.
